(19) United States
(12) Patent Application Publication
(10) Pub. No.: US 2017/0184410 A1
(43) Pub. Date: Jun. 29, 2017

(54) METHOD AND ELECTRONIC DEVICE FOR PERSONALIZED NAVIGATION

(71) Applicants: Le Holdings (Beijing) Co., Ltd., Beijing (CN); Le Shi Internet Information & Technology Corp. Beijing, Beijing (CN)

(72) Inventor: Lei ZHANG, Beijing (CN)

(21) Appl. No.: 15/250,667

(22) Filed: Aug. 29, 2016

Related U.S. Application Data
(63) Continuation of application No. PCT/CN2016/088952, filed on Jul. 6, 2016.

(30) Foreign Application Priority Data
Dec. 29, 2015 (CN) 201511009855.1

(51) Int. Cl. G01C 21/36; H04W 4/04; G01C 21/34; H04W 4/02

(52) U.S. Cl. CPC G01C 21/3617; H04W 4/028; H04W 4/046; G01C 21/3446

(57) ABSTRACT

A method and an electronic device for personalized navigation. The electronic device for personalized navigation acquire history data of a user, the history data comprising location information associated with active time of the user; plan a routine active path of the user according to the acquired history data; acquire navigation paths of the user; and classify the navigation paths into the routine active path and a non-routine active path according to the planned routine active path of the user, and provide navigation information to the user according to the classification result.

### CROSS REFERENCE TO RELATED APPLICATIONS

The present disclosure is a continuation of International Application No. PCT/CN2016/088952, filed on Jul. 6, 2016, which is based upon and priority to Chinese Patent Application No. 201511009855.1 filed on Dec. 29, 2015, the entire contents of all of which are incorporated herein by reference.

### TECHNICAL FIELD

The present disclosure relates to the technical field of mobile communications, and more particularly, to a method and an electronic device for personalized navigation.

### BACKGROUND

A live view navigation manner is provided in the related art, and specifically, in the travelling process of a vehicle, an image collection apparatus of a navigation device collects in real time a live view image of the location of the vehicle, and the navigation device determines navigation prompt information (such as go-straight prompt information, turn-left prompt information, and turn-right prompt information) according to the current location of a user, the current driving direction and a navigation path, superimposes arrows corresponding to the determined navigation prompt information in the live view image, and displays the live view image; in this way, the user can not only check the road situation according to the live view image, but also can acquire in real time the navigation prompt information in driving.

However, regardless of e-map navigation or live view navigation, an existing system for navigation cannot perform navigation intelligently from a user's perspective.

### SUMMARY

An embodiment of the present disclosure provides a method for personalized navigation, including: at an electronic device; acquiring history data of a user, the history data including location information associated with active time of the user; planning a routine active path of the user according to the acquired history data; acquiring navigation paths of the user; and classifying the navigation paths into the routine active path and a non-routine active path according to the planned routine active path of the user, and providing navigation information to the user according to the classification result.

An embodiment of the present disclosure provides a non-volatile computer-readable storage medium stored with computer executable instructions, the computer executable instructions perform any one of the method for personalized navigation described above in the disclosure.

An embodiment of the present disclosure provides an electronic device, including: at least one processor: and a memory; wherein, the memory is communicably connected with the at least one processor and for storing instructions executed by the at least one processor, the computer executable instructions perform any one of the method for personalized navigation described above in the disclosure.

### BRIEF DESCRIPTION OF THE DRAWINGS

One or more embodiments are illustrated by way of examples, and not by limitation, in the figures of the accompanying drawings, wherein elements having the same reference numeral designations represent like elements throughout. The drawings are not to scale, unless otherwise disclosed.

FIG. 1 is a flowchart illustrating a method for personalized navigation according to an embodiment of the present disclosure; and

FIG. 2 is a diagram illustrating functional modules of a system for personalized navigation according to an embodiment of the present disclosure.

FIG. 3 is a block diagram of an electronic device used to perform the method for personalized navigation according to embodiments of the present disclosure.

### DETAILED DESCRIPTION

To make the objectives, technical solutions and advantages of the present disclosure clearer, the technical solutions in the specific embodiments of the present disclosure are described clearly and completely with reference to the accompanying drawings in the embodiments of the present disclosure. Apparently, the described embodiments are merely some of rather than all of the embodiments of the present disclosure. Based on the embodiments of the present disclosure, all other embodiments derived by persons of ordinary skill in the art without any creative efforts shall fall within the protection scope of the present disclosure.

Although the processes described below include multiple operations performed in a specific order, it should be clearly understood that these processes may include more or fewer operations and these operations may be executed in sequence or in parallel (for example, using parallel processors or a multi-thread environment).

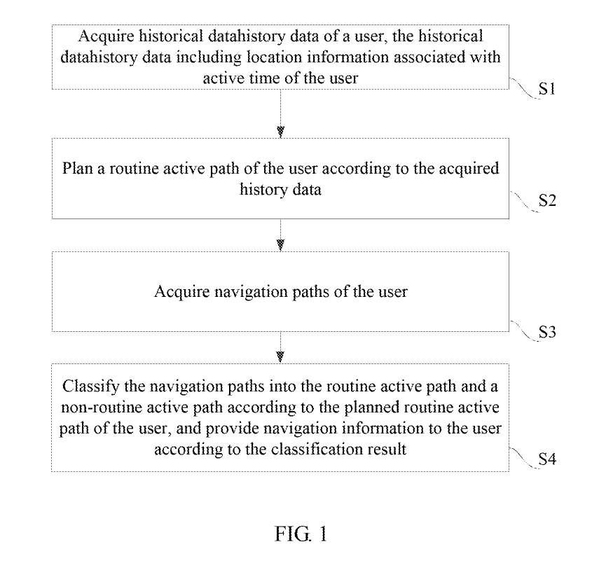

FIG. 1 is a flowchart illustrating a method for personalized navigation according to embodiments of the present disclosure. As illustrated in FIG. 1, the method may include:

In step S1: history data of a user is acquired, wherein the history data includes location information associated with active time of the user.

In a specific embodiment of the present disclosure, geographical locations and the time associated with each geographical location of an automobile may be recorded by using various types of sensors installed on the automobile.

For example, a user often visits a geographical location A, a geographical location B and a geographical location C, and stays at the geographical location A for a period of time from 8 a.m. to 5 p.m. on Monday to Friday, stays at the geographical location B for a period of time everyday from 6 p.m. to 7 a.m. the next day, and stays at the geographical location C for a period of time from 3 p.m. to 4 p.m. on Saturday.

Such location information associated with the active time of the user may be used to deduce the state of the environment that the user is in.

For example, the geographical location A may be the workplace of the user, the geographical location B may be the residence of the user, and the geographical location C may be an outdoor place visited by the user.

In step S2: a routine active path of the user is planned according to the acquired history data.

In a specific embodiment of the present disclosure, the history data in Step S1 may be recorded in a system for personalized navigation provided by a specific embodiment of the present disclosure, and the history data may be analyzed to obtain the driving habits of the user and a routine active range of the user.

Specifically, in a specific embodiment of the present disclosure, visited locations of the user may be acquired from the history data, and cluster analysis is performed on the acquired visited locations to generate a preset number of cluster areas. The cluster analysis includes, but is not limited to, a K-MEANS algorithm, an agglomerative hierarchical cluster algorithm or a BSCAN algorithm.

The cluster analysis process is briefly introduced herein by taking the DBSCAN algorithm as an example. DBSCAN (Density-Based Spatial Cluster of Applications with Noise) is a density-based spatial cluster algorithm. This algorithm can classify areas of sufficient density into a cluster, find clusters of any shape in a spatial database with noises, and define a cluster as a maximum set of density-connected points. The purpose of the DBSCAN algorithm is to filter out low-density areas and find high-density sample points.

Different from conventional convex clusters based on hierarchical cluster and partitioning cluster, clusters of any shape may be found by this algorithm, and this algorithm has the following advantages as compared with the conventional algorithm:

(1) the number of clusters to be classified does not need to be input as compared with K-MEANS;

(2) the shape of clusters has no preference;

(3) a noise filtering parameter may be input when necessary.

This algorithm utilizes the concept of density-based cluster, that is, it is required that the number of objects (may be points or other spatial objects) covered in a certain area of a cluster space needs to be not less than a specified threshold.

The significant advantages of the DBSCAN algorithm are high cluster speed and capabilities of effectively processing noise points and finding spatial clusters of any shape.

This algorithm is specifically described as follows:

(1) an object p that has not been checked in the database is detected, if p is processed (classified into a certain cluster or marked as noises), checking a neighboring area thereof, and if the number of the covered objects is not less than minPts, establishing a new cluster C and adding all the points in the cluster C into a candidate set N;

(2) neighboring areas of all the unprocessed objects q in the candidate set N are checked, if at least minPts objects are covered, adding these objects into N; and if q is not classified into any cluster, adding q into C;

(3) repeating Step (2), and unprocessed objects in N are continuously checked, wherein the current candidate set N is null;

(4) repeating Steps (1) to (3), till all the objects are classified into a certain cluster or marked as noises.

The pseudocode of this algorithm is described as follows:

input: data object set D, radius Eps, density threshold MinPts
output: cluster C
DBSCAN (D, Eps, MinPts)
Begin
init C=0; //the number of initialized clusters is 0
for each unvisited point p in D
mark p as visited; //p is marked as visited
N = getNeighbours (p, Eps);
if sizeOf(N) < MinPts then
mark p as Noise; //if sizeOf(N) < MinPts is satisfied, p is marked as Noise
else
C= next cluster; //a new cluster C is established
ExpandCluster (p, N, C, Eps, MinPts);
end if
end for
End

The pseudocode of ExpandCluster algorithm is as follows:

ExpandCluster(p, N, C, Eps, MinPts)
add p to cluster C; //a core point is added into C first
for each point p′ in N
mark p′ as visited;
N′ = getNeighbours (p′, Eps); //the radius of all the points in the

neighboring area of N is checked

if sizeOf(N′) >= MinPts then
N = N+N′; //if sizeOf(N′) > MinPts, the number of N is expanded
end if
if p′ is not member of any cluster
add p′ to cluster C; //p′ is added into the cluster C
end if
end for
End ExpandCluster

By means of the above algorithm, geographical locations where the user often visits in the history data may be clustered to form a preset number of cluster areas.

After the preset number of cluster areas are acquired, acquire aggregation points in the corresponding to the cluster areas by means of clustering on the clustering areas. In this way a cluster area of a certain range can be concentrated to one aggregation point, and thus path planning can be performed conveniently.

Specifically, in a specific embodiment of the present disclosure, the coordinates of multiple geographical locations in the same cluster area may be added and then divided by the number of the geographical locations to obtain the coordinates of the center point of the cluster area, and the center point may serve as the aggregation point of the cluster area.

Next, in a specific embodiment of the present disclosure, corresponding visiting time may be allocated to the acquired aggregation points according to the location information associated with the active time of the user in the history data. For example, if each geographical location in a cluster area corresponding to an aggregation point A is corresponding to a period of time from 8 a.m. to 5 p.m., the period of time from 8 a.m. to 5 p.m. may be allocated to the aggregation point A.

In this way, each acquired aggregation point may be corresponding to one period of visiting time, and a routine active path may be determined among the aggregation points according to the visiting time corresponding to each aggregation point. For example, the visiting time corresponding to the aggregation point A is from 8 a.m. to 5 p.m., the visiting time corresponding to an aggregation point B is from 6 p.m. to 7 a.m. the next day, and thus a active path may be established between the aggregation point A and the aggregation point B, and this active path may be set as a routine active path of the user.

In step S3:navigation paths of the user are acquired.

In a specific embodiment of the present disclosure, the system for personalized navigation may receive a start location and a target location input by a user, so as to provide a navigation path from the start location to the target location.

In step S4:the navigation paths are classified into the routine active path and a non-routine active path according to the planned routine active path of the user, and navigation information is provided to the user according to the classification result.

After the navigation paths are acquired, in a specific embodiment of the present disclosure, the navigation paths are classified into the routine active path and a non-routine active path according to the planned routine active path of the user.

Specifically, in a specific embodiment of the present disclosure, the system for personalized navigation may acquire a first path coordinate set of the routine active path of the user and a second path coordinate set of the navigation path, and then determine coincident path coordinates in the first path coordinate set and the second path coordinate set. The path formed by the coincident path coordinates is a path that the user is familiar with, that is, in a specific embodiment of the present disclosure, a path formed by the coincident path coordinates may be classified as the routine active path. Correspondingly, a path formed by path coordinates other than the coincident path coordinates in the second path coordinate set may be classified as a non-routine active path.

In this way, the navigation paths may be classified into the routine active path and the non-routine active path. In a specific embodiment of the present disclosure, different navigation prompt policies may be adopted for different path types.

Specifically, in a specific embodiment of the present disclosure, an association may be pre-established between frequency of the navigation prompt information and a path type. For example, for the routine active path, the frequency of the navigation prompt information may be reduced, and the user may be reminded using concise navigation voice. On the contrary, for the non-routine active path, the user may be reminded at a high frequency and using complicated navigation voice. In this way, the system for personalized navigation may send the navigation prompt information to the user according to the frequency of the navigation prompt information that is associated with the type of the path on which the user is located currently.

Specifically, the navigation prompt information may include estimated driving time required for passing this path. Therefore, when the user is currently on the routine active path, because the user is familiar with the path, the driving time is shorter than the estimated driving time normally provided by the system for navigation.

In this way, in a specific embodiment of the present disclosure, the estimated driving time required to pass the routine active path may be calculated according to history driving speed data of the user on the routine active path, and the calculated estimated driving time is sent to the user. Therefore, accurate estimated driving time may be provided to the user correspondingly according to the driving habits of the user in a familiar road section.

Besides, in a specific embodiment of the present disclosure, information of the places that the user often visits may be intelligently provided to the user according to visiting habits of the user on the destination. Specifically, when the distance between the user and a navigation destination is less than a preset distance, routine visited sites of the user in a preset range of the navigation destination may be determined, and information of the determined routine visited sites is sent to the user. In this way, when the user is about to reach the destination, the user may acquire related information about the places where the user often visits, thereby receiving great convenience.

In view of the above, according to the method for personalized navigation provided by the specific embodiment of the present disclosure, locations where a user often visits and the visiting time at each location may be determined by analyzing history data of the user. Path planning may be performed on the determined locations according to the active time of the user, thereby determining a routine active path of the user. When the user is on the routine active path, navigation information does not need to be prompted too frequently and it takes a short time to pass this road section. In this way, by classifying the navigation paths of the user into the routine active path and a non-routine active path, different navigation information may be provided to the user according to the different path types, thereby providing a personalized navigation service to the user.

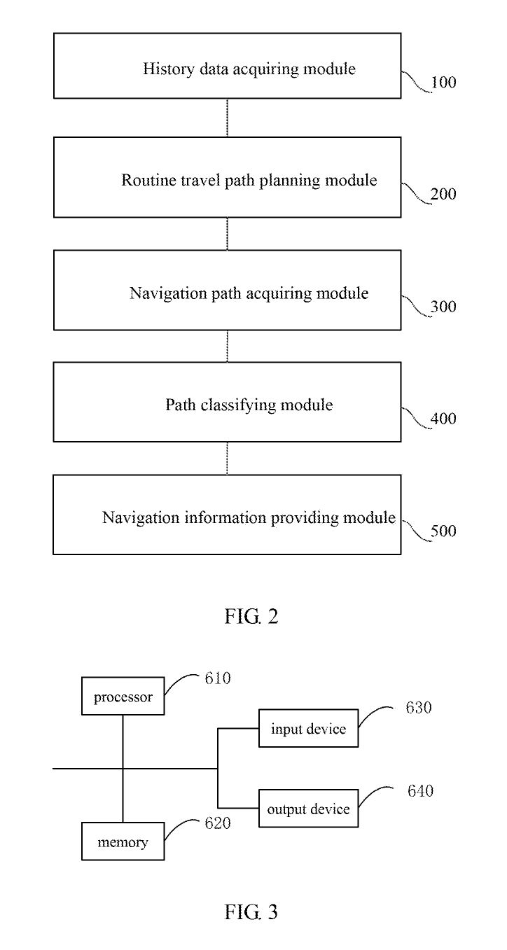

embodiments of the present disclosure further provides a system for personalized navigation. FIG. 2 is a diagram illustrating functional modules of a system for personalized navigation according to embodiments of the present disclosure.

As illustrated in FIG. 2, the system may include:

a history data acquiring module 100 acquires history data of a user, the history data including location information associated with active time of the user;

a routine active path planning module 200 plans a routine active path of the user according to the acquired history data;

a navigation path acquiring module 300 acquires navigation paths of the user;

a path classifying module 400 classifies the navigation paths into the routine active path and a non-routine active path according to the planned routine active path of the user; and

a navigation information providing module 500 provides navigation information to the user according to the classification result.

The routine active path planning module 200 may specifically include:

a cluster analysis module acquires visited locations of the user from the history data, and perform cluster analysis on the acquired visited locations to generate a preset number of cluster areas:

an aggregation point acquiring module performs a cluster manner on the preset number of cluster areas to acquire aggregation points in the corresponding cluster areas;

a visiting time allocating module allocates corresponding visiting time to the acquired aggregation points according to the location information associated with the active time of the user in the history data; and

a path determining module determines a routine active path among the aggregation points according to the visiting time associated with each aggregation point.

The cluster analysis may include a K-MEANS algorithm, an agglomerative hierarchical cluster algorithm or a DBSCAN algorithm.

In a specific embodiment of the present disclosure, the path classifying module 400 may specifically include:

a coordinate set acquiring module acquires a first path coordinate set of the routine active path of the user and a second path coordinate set of the navigation path;

a coincident path coordinate determining module determines coincident path coordinates in the first path coordinate set and the second path coordinate set;

a routine active path classifying module classifies a path formed by the coincident path coordinates as the routine active path; and

a non-routine active path classifying module classifies a path formed by path coordinates other than the coincident path coordinates in the second path coordinate set as a non-routine active path.

In a specific embodiment of the present disclosure the navigation information providing module 500 may specifically include:

an association relationship establishing module pre-establishes an association relationship between the frequency of the navigation prompt information and the path type; and

a prompt information sending module sends the navigation prompt information to the user according to the frequency of the navigation prompt information that is associated with the type of the path that the user is currently on.

It should be noted that, the specific implementing process of each functional module is consistent with Steps S1 to S4, and the details may not be repeated herein.

In view of the above, according to the system for personalized navigation provided by the specific embodiment of the present disclosure, locations where a user often visits and the visiting time at each location may be determined by analyzing history data of the user. Path planning may be performed on the determined locations according to the active time of the user, thereby determining a routine active path of the user. When the user is on the routine active path, navigation information does not need to be prompted too frequently and it takes a short time to pass this road section. In this way, by classifying the navigation paths of the user into the routine active path and a non-routine active path, different navigation information may be provided to the user according to the different path types, thereby providing a personalized navigation service to the user.

Embodiments of the present disclosure further provide a non-volatile computer-readable storage medium, the non-volatile computer-readable storage medium is stored with computer executable instructions which are perform any of the embodiments described above of the method for personalized navigation.

FIG. 3 is a block diagram of an electronic device used to perform the method for personalized navigation according to embodiments of the present disclosure, as shown in FIG. 3, the device includes:

One or more processors 610 and a memory 620, FIG. 3 illustrates one processor 610 as an example.

The device for the method for personalized navigation may further include an input device 630 and an output device 630.

The processor 610, the memory 620, the input device 630 and the output device 630 may be connected with each other through bus or other forms of connections. FIG. 3 illustrates bus connection as an example.

As a non-volatile computer-readable storage medium, the memory 620 store non-volatile software program, non-volatile computer executable program and modules, such as program instructions/modules corresponding to the method for personalized navigation according to the embodiments of the disclosure (for example, history data acquiring module 100, routine active path planning module 200 and the navigation path acquiring module 300, as illustrated in FIG. 2). By executing the non-volatile software program, instructions and modules stored in the memory 620, the processor 610 may perform various functional applications of the server and data processing, that is, the method for personalized navigation according to the above mentioned embodiments.

The memory 620 may include a program storage area and a data storage area, wherein, the program storage area may be stored with the operating system and applications which are needed by at least one functions, and the data storage area may be stored with data which is created according to use of the device for personalized navigation. Further, the memory 620 may include a high-speed random access memory, and may further include non-volatile memory, such as at least one of disk memory device, flash memory device or other types of non-volatile solid state memory device. In some embodiments, optionally, the memory 620 may include memory provided remotely from the processor 610, and such remote memory may be connected with the device for personalized navigation through network connections, the examples of the network connections may include but not limited to internet, intranet, LAN (Local Area Network), mobile communication network or combinations thereof.

The input device 630 may receive inputted number or character information, and generate key signal input related to the user settings and functional control of the device for personalized navigation. The output device 630 may include a display device such as a display screen.

The above one or more modules may be stored in the memory 620, when these modules are executed by the one or more processors 610, the method for personalized navigation according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(3) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Various embodiments in the specification are described in a progressive manner. The same or similar parts between the embodiments may be referenced to each other. In each embodiment, the portion that is different from other embodiments is concentrated and described. In particular, with respect to a system embodiment, since it is substantially similar to the method embodiment, brief description is given. The related portions may be referenced to the description of the portions in the method embodiment.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for personalized navigation, comprising:
at an electronic device:
acquiring history data of a user, the history data comprising location information associated with active time of the user;
planning a routine active path of the user according to the acquired history data;
acquiring navigation paths of the user; and
classifying the navigation paths into the routine active path and a non-routine active path according to the planned routine active path of the user, and providing navigation information to the user according to the classification result.

2. The method according to claim 1, wherein the step of planning a routine active path of the user according to the acquired history data comprises:
acquiring an active location of the user from the history data, and performing cluster analysis on the acquired active location to generate a preset number of cluster areas;
acquiring aggregation points corresponding to the cluster areas by means of cluster on the cluster areas;
allocating active time corresponding to the acquired aggregation points according to the location information associated with the user active time in the history data; and
determining a routine active path among the aggregation points according to the active time corresponding to each aggregation point.

3. The method according to claim 2, wherein the cluster analysis comprises a K-MEANS algorithm, an agglomerative hierarchical cluster algorithm or a DBSCAN algorithm.

4. The method according to claim 1, wherein the step of classifying the navigation paths into the routine active path and anon-routine active path according to the planned routine active path of the user comprises:
acquiring a first path coordinate set of the routine active path of the user and a second path coordinate set of the navigation path;
determining a coincident path coordinate in the first path coordinate set and the second path coordinate set;
classifying a path formed by the coincident path coordinate as the routine active path; and
classifying a path formed by a path coordinate other than the coincident path coordinate in the second path coordinate set as a non-routine active path.

5. The method according to claim 1, wherein the step of providing navigation information to the user according to the classification result comprises:
pre-establishing an association between frequency of the navigation prompt information and a path type; and
sending navigation prompt information to the user according to the frequency of the navigation prompt information associated with the type of the path on which the user is located currently.

6. The method according to claim 5, wherein the navigation prompt information comprises estimated driving time;
the step of sending navigation prompt information to the user comprises:
calculating the estimated driving time required to pass the routine active path according to history driving speed data of the user on the routine active path, when the user is currently on the routine active path; and
sending the calculated estimated driving time to the user.

7. The method according to claim 5, wherein the step of sending navigation prompt information to the user comprises:
determining a routine active site of the user in a preset range of the navigation destination, when the distance between the user and a navigation destination is less than a preset distance, and sending information of the determined routine active site to the user.

8. A non-volatile computer-readable storage medium stored with computer executable instructions, when executed by an electronic device, causes the electronic device to:
acquire history data of a user, the history data comprise location information associated with active time of the user;
plan a routine active path of the user according to the acquired history data;
acquire navigation paths of the user; and
classify the navigation paths into the routine active path and a non-routine active path according to the planned routine active path of the user, and provide navigation information to the user according to the classification result.

9. The non-volatile computer-readable storage medium according to claim 8, wherein, the instructions to plan a routine active path of the user according to the acquired history data cause the electronic device to:
acquire an active location of the user from the history data, and perform cluster analysis on the acquired active location to generate a preset number of cluster areas;
acquire aggregation points corresponding to the cluster areas by means of cluster on the cluster areas;
allocate active time corresponding to the acquired aggregation points according to the location information associated with the user active time in the history data; and
determine a routine active path among the aggregation points according to the active time corresponding to each aggregation point.

10. The non-volatile computer-readable storage medium according to claim 8, wherein the instructions to classify the navigation paths into the routine active path and a non-routine active path according to the planned routine active path of the user cause the electronic device to:
acquire a first path coordinate set of the routine active path of the user and a second path coordinate set of the navigation path;
determine a coincident path coordinate in the first path coordinate set and the second path coordinate set;
classify a path formed by the coincident path coordinate as the routine active path; and
classify a path formed by a path coordinate other than the coincident path coordinate in the second path coordinate set as a non-routine active path.

11. The non-volatile computer-readable storage medium according to claim 8, wherein the instructions to provide navigation information to the user according to the classification result cause the electronic device to:
pre-establish an association between frequency of the navigation prompt information and a path type; and
send navigation prompt information to the user according to the frequency of the navigation prompt information associated with the type of the path on which the user is located currently.

12. The non-volatile computer-readable storage medium according to claim wherein the navigation prompt information comprises estimated driving time;
the instructions to send navigation prompt information to the user cause the electronic device to:
calculate the estimated driving time required to pass the routine active path according to history driving speed data of the user on the routine active path, when the user is currently on the routine active path; and
send the calculated estimated driving time to the user.

13. The non-volatile computer-readable storage medium according to claim 8, wherein the instructions to send navigation prompt information to the user cause the electronic device to:
determine a routine active site of the user in a preset range of the navigation destination, when the distance between the user and a navigation destination is less than a preset distance, and send information of the determined routine active site to the user.

14. An electronic device, comprising:
at least one processor; and
a memory, communicably connected with the at least one processor and for storing instructions executed by the at least one processor,
wherein execution of the instructions by the at least one processor causes the at least one processor to:
acquire history data of a user, the history data comprising location information associated with active time of the user;
plan a routine active path of the user according to the acquired history data;
acquire navigation paths of the user; and
classify the navigation paths into the routine active path and a non-routine active path according to the planned routine active path of the user, and provide navigation information to the user according to the classification result.

15. The electronic device according to claim 14, wherein the instructions to plana routine active path of the user according to the acquired history data cause the at least one processor to:
acquire an active location of the user from the history data, and performing cluster analysis on the acquired active location to generate a preset number of cluster areas;
acquire aggregation points corresponding to the cluster areas by means of cluster on the cluster areas;
allocate active time corresponding to the acquired aggregation points according to the location information associated with the user active time in the history data; and
determine a routine active path among the aggregation points according to the active time corresponding to each aggregation point.

16. The electronic device according to claim 14, wherein the instructions to classify the navigation paths into the routine active path and a non-routine active path according to the planned routine active path of the user cause the at least one processor to:
acquire a first path coordinate set of the routine active path of the user and a second path coordinate set of the navigation path:
determining a coincident path coordinate in the first path coordinate set and the second path coordinate set;
classify a path formed by the coincident path coordinate as the routine active path; and
classify a path formed by a path coordinate other than the coincident path coordinate in the second path coordinate set as a non-routine active path.

17. The electronic device according to claim 14, wherein the instructions to provide navigation information to the user according to the classification result cause the at least one processor to:
pre-establish an association between frequency of the navigation prompt information and a path type; and
send navigation prompt information to the user according to the frequency of the navigation prompt information associated with the type of the path on which the user is located currently.

18. The electronic device according to claim 14, wherein the navigation prompt information comprises estimated driving time;
the instructions to send navigation prompt information to the user cause the at least one processor to:
calculate the estimated driving time required to pass the routine active path according to history driving speed data of the user on the routine active path, when the user is currently on the routine active path; and
send the calculated estimated driving time to the user.

19. The electronic device according to claim 14, wherein the instructions to send navigation prompt information to the user cause the at least one processor to:
determine a routine active site of the user in a preset range of the navigation destination, when the distance between the user and a navigation destination is less than a preset distance, and send information of the determined routine active site to the user.
